(19) United States
(12) Patent Application Publication
(10) Pub. No.: US 2025/0230286 A1
(43) Pub. Date: Jul. 17, 2025

(54) CHEMICALLY END-CAPPED POLYPIPERAZINE PYROPHOSPHATE-MODIFIED AMMONIUM POLYPHOSPHATE WITH HIGH TEMPERATURE RESISTANCE AND PRECIPITATION RESISTANCE, PREPARATION METHOD THEREFOR, AND APPARATUS AND APPLICATION THEREOF

(71) Applicants: Chongqing Copolyforce New Materials Co.,Ltd., Chongqing (CN); CCTEG CHONGQING RESEARCH INSTITUTE, Chongqing (CN)

(72) Inventors: Zhi HU, Chongqing (CN); Zhiqiang ZHONG, Chongqing (CN); Yuchen WANG, Chongqing (CN); Xiaodi GONG, Chongqing (CN); Tao SHI, Chongqing (CN); Xueliang DING, Chongqing (CN); Qing MEI, Chongqing (CN); Xu XU, Chongqing (CN); Lei ZHOU, Chongqing (CN); Jian CHEN, Chongqing (CN); Qiang LV, Chongqing (CN); Fushun LI, Chongqing (CN); Xin ZHOU, Chongqing (CN); Quanguo HE, Chongqing (CN); Shuying YE, Chongqing (CN); Xiaolin LIU, Chongqing (CN); Gang LIU, Chongqing (CN)

(73) Assignees: Chongqing Copolyforce New Materials Co.,Ltd., Chongqing (CN); CCTEG CHONGQING RESEARCH INSTITUTE, Chongqing (CN)

(21) Appl. No.: 19/019,912

(22) Filed: Jan. 14, 2025

Related U.S. Application Data
(63) Continuation of application No. PCT/CN2024/105802, filed on Jul. 16, 2024.

(30) Foreign Application Priority Data
May 17, 2023 (CN) 202310559969.1

(51) Int. Cl. C08G 79/04; C07F 9/24

(52) U.S. Cl. CPC C08G 79/04; C07F 9/2458

(57) ABSTRACT

Disclosed are chemically end-capped polypiperazine pyrophosphate-modified ammonium polyphosphate with high temperature resistance and precipitation resistance, a preparation method therefor, and an apparatus and application thereof. The chemically end-capped polypiperazine pyrophosphate-modified ammonium polyphosphate flame retardant is formed by polypiperazine pyrophosphate modification based on ammonium polyphosphate, followed by end capping; and the polypiperazine pyrophosphate is prepared by polymerization of an intermediate piperazine diphosphate obtained through dehydration condensation of phosphoric acid and piperazine. The chemically end-capped polypiperazine pyrophosphate-modified ammonium polyphosphate flame retardant of the present solution is prepared by using special equipment, which ensures whiteness and thermal stability of product, and improves properties of ammonium polyphosphate. The chemically end-capped polypiperazine pyrophosphate-modified ammonium polyphosphate flame retardant is further applied to preparation of flame-retardant polypropylene, so that flame-retardancy, temperature resistance and precipitation resistance of the flame retardant in a polypropylene system can be improved.

### CROSS-REFERENCE TO RELATED APPLICATIONS

The application claims priority to Chinese patent application No. 202310559969.1, filed on May 17, 2023, the entire contents of which are incorporated herein by reference.

### TECHNICAL FIELD

The present disclosure relates to the technical field of flame retardants, and specifically relates to >chemically end-capped polypiperazine pyrophosphate-modified ammonium polyphosphate with high temperature resistance and precipitation resistance, a preparation method therefor, and an apparatus and application thereof.

### BACKGROUND

Ammonium polyphosphate (APP), also known as polyammonium phosphate or condensed ammonium phosphate, is a long-chain inorganic element polymer containing phosphorus and nitrogen, and its general molecular formula is (NH4)ₙ₊₂ PnO₃ₙ₊₁.Degrees of APP polymerization can fall into three categories: oligomerization, mesomerization and high polymerization. A higher degree of polymerization indicates smaller water solubility, and vice versa. By structure, APP can be divided into crystalline APP and amorphous APP, where the crystalline APP is a long-chain water-insoluble salt. Due to its advantages such as good chemical stability, low hygroscopicity, excellent dispersibility, a low specific gravity and low toxicity, APP has been widely used as a flame retardant for plastics, rubbers and fibers in recent years; APP can also be used to prepare intumescent fire-retardant coatings for fire protection of ships, trains, cables and high-rise buildings; and APP is also used to produce dry powder fire extinguishing agents for large-scale fire extinguishing in coal fields, oil wells and forests. Quality of APP as a flame retardant depends on its degree of polymerization. The higher degree of polymerization indicates higher thermal stability and better water resistance. As an acid source and a gas source of a halogen-free intumescent flame retardant (IFR) system, APP can promote a polymer to form an intumescent carbon layer in a condensed phase to isolate oxygen during combustion, and generate ammonia, and generate ammonia, water vapor and the like to dilute a combustible gas concentration in a gas phase, so as to slow down a combustion process of a material. When used as a flame retardant, APP usually needs to be combined with other substances that are capable of providing carbon and gas sources to form an intumescent flame retardant in order to better exert a flame-retardant effect.

Those skilled in the art have attempted to improve properties of APP through synthetic methods. Currently, main raw materials used for producing APP include phosphoric acid, phosphorus pentoxide, monoammonium phosphate (MAP), diammonium phosphate (DAP), urea phosphate, urea, melamine (MA) and dicyandiamide. Synthetic methods have been explored at home and abroad, and it is expected to find out a method for synthesizing high-polymerization, low-water-solubility and high-temperature-resistant APP. Results of current researches at home and abroad show that APP prepared by improving a synthesis process has been improved to a certain extent in terms of the polymerization degree, the water solubility and the thermal stability, but due to structural limitations, problems of APP cannot be fundamentally solved, so other methods need to be considered for optimization of APP.

Those skilled in the art have also attempted to improve the properties of APP by compounding with other ingredients. The prior art document “Zhang Yan, Research on a Flame Retardant Application of Polypiperazine Pyrophosphate/Ammonium Polyphosphate on Wollastonite-Reinforced Polypropylene, Plastic Industry, May 2022” reports research results of a combined use of APP and polypiperazine pyrophosphate (PAPP) to enhance the flame retardant effect on wollastonite-reinforced polypropylene. PAPP has good water resistance and charring properties, and contains an acid source, a carbon source and a gas source. PAPP can be used as a single-component IFR and play a flame retardant role in both a gas phase and a condensed phase. Although PAPP can overcome defects of APP, PAPP/APP, in a flame retardant system, needs to be added in a larger amount to play a role, but addition of a large amount of flame retardant will negatively impact mechanical properties of a main material.

In addition to attempting to compound APP with other flame retardants, researchers skilled in the art have also explored chemical modification of APP. Widely used surface modification, surface activation and microencapsulation are difficult to achieve a desired effect due to inherent physical and chemical properties of APP. Main reasons are as follows: (1) Defects exist in a molecular structure of APP. Regardless of any crystal form, ammonium salt will begin to decompose at around 300° C., so its maximum decomposition temperature can hardly exceed 320° C.; and a molecular chain of APP is easily degraded and broken in a strongly acidic or alkaline solution, so its modification can be achieved only in a relatively mild environment. (2) As a typical inorganic macromolecular polyphosphate, APP has no active reactive groups, so it is difficult to chemically modify APP structurally. After the microencapsulation, there is no chemical bond between a core material and a capsule wall material, and due to a simple physical coating, APP is easily affected by an external force and a shear force in a process of crushing, processing and blending, and a shell layer is damaged, such that an effect of the microencapsulation is reduced.

To sum up, although APP has advantages of low cost, environmental protection, wide application and the like, APP, due to its molecular structure defects and other reasons, cannot meet the needs of practical applications in comprehensive properties. Therefore, there is an urgent need to seek a new APP modification method to comprehensively improve the properties of APP.

### SUMMARY

An objective of the present disclosure is to provide a chemically end-capped polypiperazine pyrophosphate (PAPP)-modified ammonium polyphosphate (APP) flame retardant with high temperature resistance and precipitation resistance, so as to overcome technical defects of APP in the prior art including non-ideal properties in a flame-retardant effect and stability.

To achieve the above objective, the present disclosure adopts the following technical solution:
a chemically end-capped PAPP-modified APP flame retardant with high temperature resistance and precipitation resistance, where a structure of the PAPP-modified APP is represented by a following chemical formula, and the PAPP-modified APP is end-capped by an end-capping reagent;

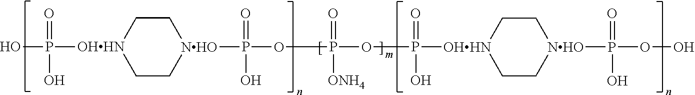

where n=300-1500, m=1000-2000; and the end-capping reagent is a nitrogen-containing compound containing no hydroxyl group but an N—H bond.

In this solution, there is further provided a method for preparing a chemically end-capped PAPP-modified APP fire retardant with high temperature resistance and precipitation resistance, and the method includes the following steps performed sequentially:
S1: dehydrating piperazine diphosphate by thermal polymerization to obtain PAPP;
S2: dehydrating the PAPP and APP by the thermal polymerization to obtain PAPP-modified APP; and
S3: performing thermal treatment of the PAPP-modified APP and the end-capping reagent, to obtain the chemically end-capped PAPP-modified APP.

In this solution, there is further provided an application of the chemically end-capped PAPP-modified APP flame retardant with high temperature resistance and precipitation resistance in flame-retardant polypropylene.

Further, the end-capping reagent includes at least one of R—NH₂, R═NH, melamine, urea, biguanide and iminodiacetonitrile; and R is an alkyl group with 1-4 carbon atoms.

Further, a molar ratio of the PAPP to the APP is 2.0-2.1:1; and a molar ratio of the end-capping reagent to the PAPP-modified APP is 2.0-2.2:1.

Further, reaction processes of S1-S3 are all executed in an inert gas environment; a reaction temperature, pressure and time of S1 are 120-320° C., 0.05-0.3 MPa, and 30-240 min, respectively; a reaction temperature, pressure and time of S2 are 150-280° C., 0.05-0.3 MPa, and 30-180 min, respectively; and a reaction temperature, pressure and time of S3 are 120-350° C., 0.1-1.5 MPa, and 30-240 min, respectively.

Further, the reaction processes of S1-S3 are all executed in a thermal polymerization reaction device; the thermal polymerization reaction device includes a rotary furnace and a temperature control unit; a reaction chamber is arranged in the rotary furnace, and a material stirring screw is coaxially arranged in the reaction chamber; the temperature control unit is configured for controlling a temperature in the reaction chamber; and during the reaction process, the material stirring screw and the reaction chamber maintain different rotation directions.

Further, a rotation speed of the material stirring screw is 30-300 rpm, and a rotation speed of the reaction chamber is 3-120 rpm.

Further, the flame-retardant polypropylene includes the following raw materials in parts by weight: 70-78 parts of polypropylene, 10-20 parts of chemically end-capped PAPP-modified APP, 5-15 parts of melamine pyrophosphate, 0.5-6 parts of a flame-retardant synergist, 0.5-2 parts of a coupling agent, 0.3-3 parts of a lubricant, and 0.2-0.5 part of an antioxidant.

Further, a melt index of polypropylene is 0-100 g/10 min; a 1% thermal weight loss of melamine pyrophosphate is ≤360° C.; the flame-retardant synergist includes at least one of anhydrous zinc borate, zinc borate 3.5 hydrate, zinc oxide, and zirconium phosphate; the coupling agent is a silane coupling agent, including at least one of an amino silane coupling agent KH-9120, an isocyanate silane coupling agent KT-930, and epoxy silane coupling agents KH-1006 and KH-9130; the lubricant includes at least one of ethylene bis stearamide, pentaerythritol stearate, silicone and amide wax; and the antioxidant includes at least one of an antioxidant 168, an antioxidant 1010 and an antioxidant 1098.

Further, the flame-retardant polypropylene is prepared by the following method: adding chemically end-capped PAPP-modified APP, melamine pyrophosphate and a flame-retardant synergist into a mixer and stirring at room temperature for 5-30 min; then increasing a temperature of the mixer to 80-160° C., and adding a coupling agent and continuing to stir for 10-30 min; after cooling to room temperature, adding polypropylene, a lubricant and an antioxidant and stirring for 5-30 min; and obtaining flame-retardant polypropylene by extruding with a twin-screw extruder.

To sum up, this technical solution improves the temperature resistance and precipitation resistance of APP by means of specific chemical end-capping and chemical modification of APP and PAPP. When the flame-retardant is applied to preparation of any composite material, flame retardancy of the composite material are enhanced as a whole. Moreover, a synthesis device of this solution can ensure uniform heating, complete polymerization, and no sticking to a reaction kettle in a synthesis process, and solves problems of unstable thermal decomposition and continuous production of solid-phase synthesis products. The flame retardant obtained by use of this process has characteristics of excellent whiteness and thermal stability. The flame retardant of this solution is particularly suitable for preparation of flame-retardant polypropylene, and comprehensively enhances various properties of flame-retardant polypropylene.

The beneficial effects of this technical solution are as follows:
(1) APP in the prior art cannot meet product requirements in terms of the temperature resistance, particularly in the precipitation resistance, and the present disclosure enhances the temperature resistance and the precipitation resistance while improving the flame-retardant effect.
(2) The synthesis device of this solution can be used for continuous scale-up production, and under conditions of using appropriate process parameters, the whiteness (the whiteness of greater than 95%) and the thermal stability (the 1% thermal weight loss of greater than 280° C.) of product can be guaranteed. In the synthesis process, the material is uniformly heated, the polymerization is uniform and complete, and the reaction kettle is not stuck, which solves the problems of unstable thermal decomposition and continuous production of solid-phase synthesis products.
(3) A flame-retardant polyolefin flame-retardant formula is updated and adjusted (to enhance the flame retardancy, the temperature resistance and the precipitation resistance). By compounding according to the flame-retardant formula and adding a flame retardant of about 15%, the flame-retardant effect reaches 1.6 mmV-0, and the product passes a UL 746C immersion test and a GB/T 2423.50 “double 85” test for 1000 h without precipitation.

### BRIEF DESCRIPTION OF DRAWINGS

FIG. 1 is a front view of a polymerization reaction device for continuous production according to Example 1.

FIG. 2 is a sectional view of FIG. 1 in an A-A direction.

FIG. 3 is a front view (a sectional view) of a material stirring screw according to Example 1.

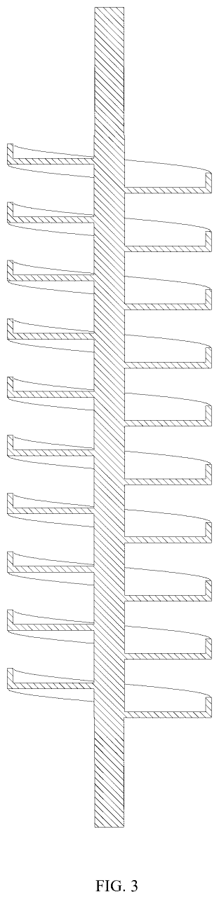

FIG. 4 is a TG chart of a commercially available ammonium polyphosphate (APP) according to Experimental Example 1.

### DETAILED DESCRIPTION OF THE EMBODIMENTS

The present disclosure will be described in further details in conjunction with examples below, but the embodiments of the present disclosure are not limited thereto. Unless otherwise specified, technical means used in the following examples and experimental examples are conventional means well known to those skilled in the art, and materials, reagents and the like can all be obtained commercially.

Reference numerals in the figures: cylinder 1, hot oil tank 2, cold oil tank 3, driven gear 4, driving gear 5, oil chamber 6, material stirring screw 7, first motor 8, feed inlet 9, nitrogen outlet 10, discharge outlet 11, nitrogen inlet 12, load-bearing wheel 13, second motor 14, support column 15, first conduit 16, first oil pump 17, second conduit 18, second oil pump 19, first rotary joint 20, first rotary conduit 21, second rotary joint 22, second rotary conduit 23, third conduit 24, frame 25, and insulation layer 26.

### Example 1: Chemically End-Capped Polypiperazine Pyrophosphate (PAPP)-Modified Ammonium Polyphosphate (APP)

### (1) Synthesis Process

A synthesis process of the chemically end-capped PAPP-modified APP is roughly as follows:
S1: Piperazine diphosphate (Formula (4)) is subjected to thermal treatment at 120-320° C. for 30-240 min, and in a polymerization device of this solution and in an inert gas environment (such as nitrogen), thermal polymerization is performed at a pressure of 0.05-0.3 MPa for dehydration and condensation into PAPP (Formula (5)) of a certain molecular weight. An intermediate piperazine diphosphate can be synthesized by using a conventional method in the prior art. For example, when phosphoric acid (Formula (2)) and piperazine (Formula (3)), at a ratio of 2.0-2.2:1 (a molar ratio), are subjected to a combination reaction and dehydration for condensation at 60-150° C. and 0.1-1.0 MPa (using a conventional reaction kettle in the prior art) for 30-300 min in a reaction system with water or alcohol as a solvent, the intermediate piperazine diphosphate can be obtained. The intermediate piperazine diphosphate used in this solution is synthesized and purified by using a conventional method of the prior art, and details about a specific process of synthesis and purification will not be described here.
S2: PAPP is used to modify APP (Formula (1)) at a usage ratio of 2.0-2.1:1 (a molar ratio), and in an inert gas environment (such as nitrogen), thermal treatment is performed at a pressure of 0.05-0.3 MPa and at 150-280° C. for 30-180 min for thermal polymerization and dehydration to obtain the PAPP-modified APP (Formula (8)).
S3: An end-capping reagent (a usage ratio of the end-capping reagent to the PAPP-modified APP is 2.0-2.2:1 (a molar ratio), the thermal treatment is continued at a temperature of 120-350° C. and a pressure of 0.1-1.5 MPa for 30-240 min in the inert gas environment (such as nitrogen), and grinding is performed after cooling to obtain the chemically end-capped PAPP-modified APP (Formula (9), taking R—NH₂ and R═NH as the end-capping reagent as an example).

A reaction formula for the synthesis of the intermediate piperazine diphosphate in the prior art is shown in Formula (10); a reaction formula for the synthesis of PAPP is shown in Formula (11) (S1); a reaction formula for the modification of APP with PAPP is shown in Formula (12) (S2); and a reaction formula for the chemically end-capped PAPP-modified APP is shown in Formula (13) (taking R—NH₂ and R═NH as the end-capping reagent as an example) (S3). In the above three-step reaction process, a material stirring screw and a cylinder of a rotary furnace rotate in different directions, and for example, when the material stirring screw rotates counterclockwise at a speed of 30-300 rpm, the cylinder of the rotary furnace rotates clockwise at a speed of 3-120 rpm (preferably 3-60 rpm).

The end-capping reagent is a nitrogen-containing compound containing no hydroxyl group but with an N—H bond, which can be R—NH₂ or R═NH, where R is an alkyl group with 1-4 carbon atoms; or melamine and its compounds without hydroxyl group composed of R—NH₂ and R═NH; or an amino compound without hydroxyl group composed of R—NH₂ and R═NH (such as urea); or an imino compound without hydroxyl group composed of R—NH₂ and R═NH (such as a compound containing a guanidine group (NH₂)₂—C═NH, biguanide (1-(diaminomethylene) guanidine), iminodiacetonitrile C₄H₅N₃). Further, in Formula (5), Formula (8), Formula (9), Formula (11) and Formula (12), n=300-1500. Further, in Formula (1), Formula (8), Formula (9), Formula (11) and Formula (12)=1000-2000. APP with a molecular weight of greater than 1000 is classified as type-II APP, which has a certain water resistance. When the molecular weight is too large (e.g., >2000), it is not conducive to a subsequent reaction. Therefore, m needs to be maintained at 1000-2000, and in the subsequent examples and comparative examples, m of the APP used is 1000-1500.

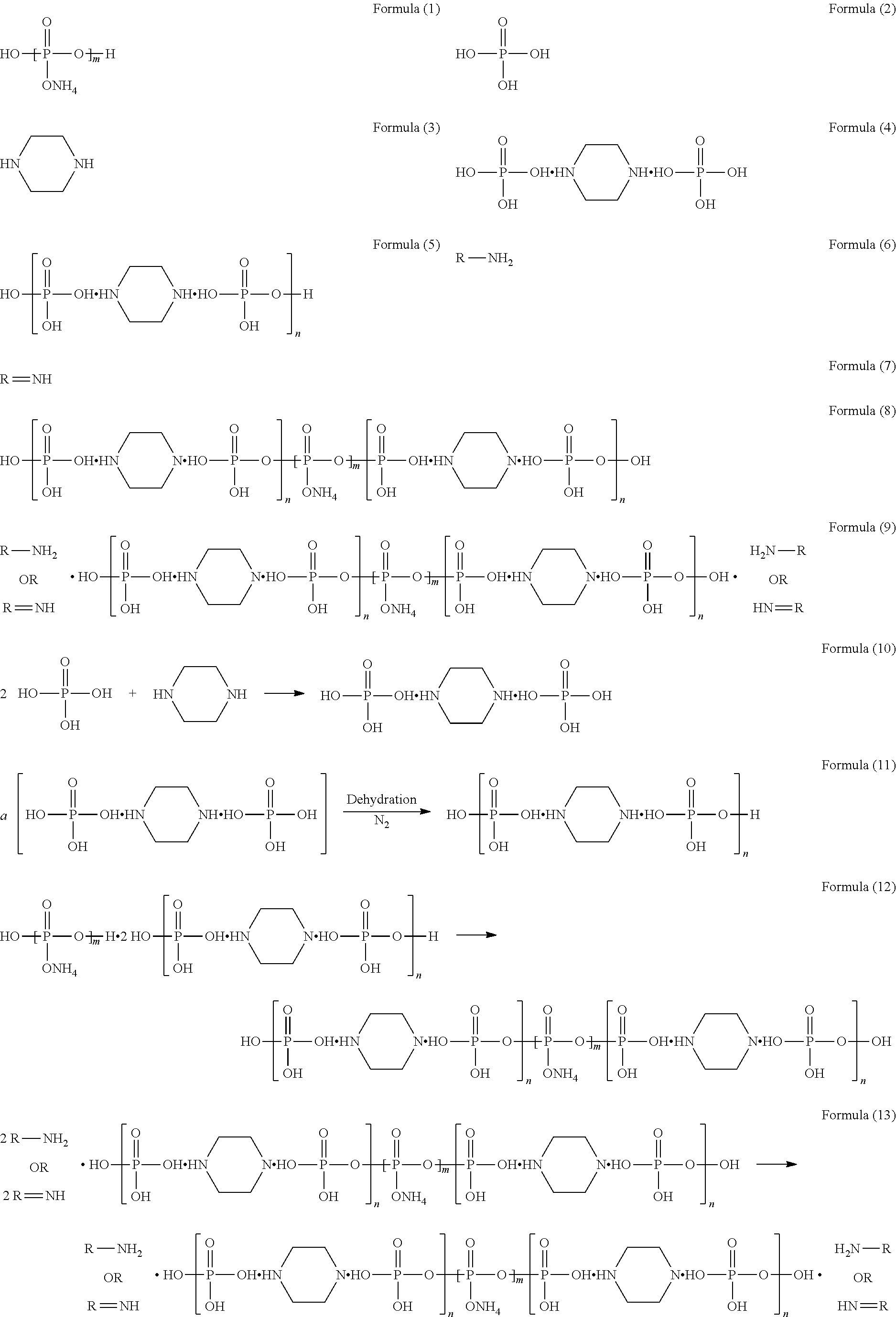

### (2) Synthesis Device

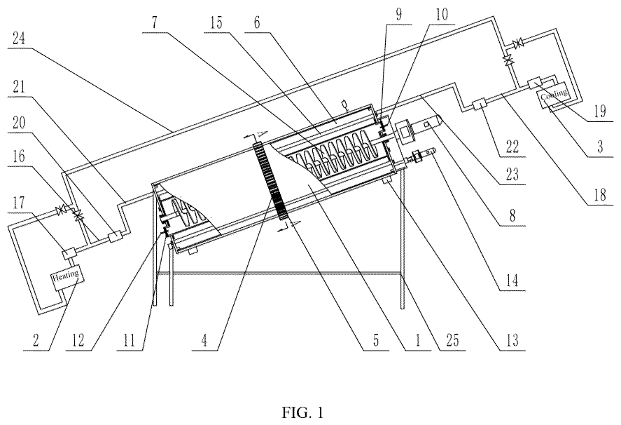

A special device used in this technical solution is shown in FIG. 1. A polymerization reaction device for continuous production includes a rotary furnace and a temperature control unit, where the rotary furnace includes an inclined cylinder 1, and the temperature control unit includes a hot oil tank 2 and a cold oil tank 3.

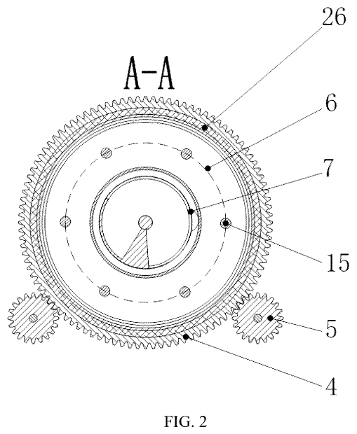

With reference to FIGS. 1 and 2, a driven gear 4 is sleeved and fixed on an outer side of the cylinder 1, the cylinder 1 and the driven gear 4 are concentrically arranged, two driving gears 5 (left and right) are meshed with the driven gear 4, and the driving gears 5 drive the cylinder 1 to rotate. The cylinder 1 has a double-layer structure, including an inner wall and an outer wall that are cylindrical and coaxially arranged, an oil chamber 6 is formed between the inner wall and the outer wall, and an outer side of the outer wall is covered with an insulation layer 26. A cavity formed by enclosing the inner wall is a reaction chamber, and a material stirring screw 7 is arranged in the reaction chamber. An upper end and a lower end of the material stirring screw 7 are rotatably connected to a top and a bottom of the cylinder 1. The upper end of the material stirring screw 7 is fixedly connected to an output shaft of a first motor 8, and the first motor 8 is fixed on the frame 25. A feed inlet 9 and a nitrogen outlet 10 are arranged at the top of the cylinder 1, and a discharge outlet 11 and a nitrogen inlet 12 are arranged at the bottom of the cylinder 1. An outer wall of the cylinder 1 is in contact with two sets of load-bearing wheels 13 from top to bottom (either set includes two load-bearing wheels 13), and the load-bearing wheels 13 are fixed in position and rotatably connected to the frame 25, which play a role of supporting the cylinder 1 and cooperate with rotation of the cylinder 1. The driving gears 5 are rotatably connected to the frame 25, a second motor 14 is fixed to the frame 25, and the driving gears 5 are driven by the second motor 14 through a conventional transmission structure in the prior art. The driving gears 5 drive the cylinder 1 to rotate through the driven gear 4. A plurality of support columns 15 parallel to a central axis of the cylinder 1 are arranged in the oil chamber 6, and upper and lower ends of the support columns 15 are fixed to the top and the bottom of the cylinder 1.

The hot oil tank 2 is communicated with a first conduit 16, and a first oil pump 17 is arranged on the first conduit 16; and the cold oil tank 3 is communicated with a second conduit 18, and a second oil pump 19 is arranged on the second conduit 18. The first conduit 16 is communicated with a first rotary conduit 21 through a first rotary joint 20; and the second conduit 18 is communicated with a second rotary conduit 23 through a second rotary joint 22. One end of the first rotary conduit 21 is communicated with the oil chamber 6 and is fixed to the bottom of the cylinder 1; and one end of the second rotary conduit 23 is communicated with the oil chamber 6 and is fixed to the top of the cylinder 1.

The temperature control unit further includes a third conduit 24. A lower end of the third conduit 24 is communicated with two branches (a branch A and a branch B), the branch B is communicated with the first conduit 16, and the branch A is communicated with the hot oil tank 2; and the branch A and the branch B are both provided with corresponding control valves. An upper end of the third conduit 24 is communicated with two branches (a branch C and a branch D), the branch D is communicated with the second conduit 18, and the branch C is communicated with the cold oil tank 3; and the branch C and the branch D are both provided with corresponding control valves. When hot oil circulates, the branch B is closed, the branch Cis closed, the second oil pump 19 is stopped, the first oil pump 17 is started, the branch A is opened, and the branch D is opened. In this way, a closed loop is formed between the hot oil tank 2, the first conduit 16, the first rotary conduit 21, the oil chamber 6, the second rotary conduit 23, the second conduit 18 and the third conduit 24. Under the action of the first oil pump 17, the hot oil circulates therein to ensure a temperature in the reaction chamber. After a heating reaction is completed, the branch A is closed, and the hot oil in a pipeline returns to the hot oil tank 2 under the action of the first oil pump 17 and a gravity of the hot oil itself. After the reaction is completed, cold oil in the cold oil tank 3 is used to cool a reacted material.

When the cold oil circulates, the branch A is closed, the branch D is closed, the first oil pump 17 is stopped, the branch B is opened, the branch C is opened, and the second oil pump 19 is started. In this way, a closed loop is formed between the cold oil tank 3, the second conduit 18, the second rotary conduit 23, the oil chamber 6, the first rotary conduit 21, the first conduit 16 and the third conduit 24. Under the action of the second oil pump 18, the cold oil circulates therein to cool down the reaction chamber. After the cooling is completed, the branch C is closed, and under the action of the second oil pump 18, the cold oil in the pipeline is pumped back to the cold oil tank 3. According to the above process, hot oil circulation and cold oil circulation can be performed alternately according to actual needs to achieve continuous production.

A specific process of using this device is as follows:
A. At the beginning of a thermal polymerization reaction, the hot oil tank 2 starts to work, the oil is heated to a processing temperature, a material and an inert protective gas are added to the reaction chamber, and the first oil pump 17 is started to press the hot oil in the hot oil tank 2 into the oil chamber 6 on the outer wall of the cylinder 1 of the rotary furnace for the thermal polymerization reaction, such that the oil circulates between the hot oil tank 2 and the oil chamber 6 on the outer wall of the cylinder 1, and is quickly heated to a specified temperature and maintains a constant temperature.
B. During the reaction process, a circulation is formed between the hot oil tank 2 and the oil chamber 6 on the outer wall of the cylinder 1 to keep the temperature constant during reaction time, and a reaction pressure is adjusted by extracting or adding the inert gas. During the entire thermal polymerization process, a rotation direction of the material stirring screw 7 remains opposite to that of the reaction chamber.
C. After the reaction is completed, the first oil pump 17 is started to pump the hot oil in the rotary furnace for the thermal polymerization reaction into the hot oil tank 2, and then the second oil pump 19 is started to press the cold oil in the cold oil tank 3 into the oil chamber 6 on the outer wall of the cylinder 1 for the thermal polymerization reaction, such that the oil circulates between the cold oil tank 3 and the oil chamber 6 on the outer wall of the rotary furnace to achieve rapid cooling.
D. After the temperature in a feeding pipe drops to a specified temperature and the material is discharged, the second oil pump 19 is started to press the oil in the oil chamber 6 on the outer wall of the rotary furnace into the cold oil tank 3, then the material and the inert protective gas are added, after air in the feeding pipe is discharged, the hot oil in the hot oil tank 2 is pressed into the oil chamber 6 on the outer wall of the cylinder 1 of the rotary furnace, and the steps A-D are repeated to achieve the continuous production.

In the synthesis process of the present technical solution, the material (piperazine diphosphate) and the inert protective gas (nitrogen, 0.05-0.3 MPa) are added to the reaction chamber, and the reaction chamber is heated to 120-320° C. and kept at a constant temperature by the hot oil circulation, and the reaction lasts for 30-240 min to complete the first step of the reaction. Then, the reaction pressure is adjusted to 0.05-0.3 MPa by introducing nitrogen, the hot oil temperature is adjusted to a reaction temperature of 150-280° C., the material (APP) is added to the reaction chamber, and after 30-180 min of the thermal polymerization and dehydration, the PAPP-modified APP is obtained. Then, the reaction pressure is adjusted to 0.1-1.5 MPa by introducing nitrogen, the hot oil temperature is adjusted to a reaction temperature of 120-350° C., the end-capping reagent is added to the reaction chamber, and the thermal treatment is performed for 30-240 min. After the reaction is completed, the material is directly discharged to a storage bin outside the system for cooling. This solution mainly serves for the synthesis of target substances, and utilizes functions of the above device including constant temperature heating, maintaining of the reaction pressure through the inert protective gas, and maintaining of the material stirring screw 7 and the reaction chamber in different directions of rotation, rather than functions of cold oil cooling and continuous production. In the use process, the material is added to the reaction chamber, the reaction chamber is filled with nitrogen to adjust to an appropriate pressure, the hot oil circulation is started to control the temperature of the reaction chamber, and the material stirring screw 7 and the reaction chamber rotate in different directions during the reaction process. The pressure of nitrogen in the reaction chamber and the temperature of the hot oil tank 2 are adjusted according to needs of different stages of the reaction. After the reaction is completed, the cold oil cooling is not performed, and the material is directly taken out and placed in the storage bin for cooling.

### Example 2: An Application of an End-Capped Polypiperazine Pyrophosphate (PAPP)-Modified Ammonium Polyphosphate (APP) in Flame-Retardant Polypropylene

The flame-retardant polypropylene includes the following raw materials in parts by weight: 70-78 parts of polypropylene, 10-20 parts of chemically end-capped PAPP-modified APP, 5-15 parts of melamine pyrophosphate, 0.5-6 parts of a flame-retardant synergist, 0.5-2 parts of a coupling agent, 0.3-3 parts of a lubricant, and 0.2-0.5 part of an antioxidant. Any flame-retardant polypropylene composition prepared by using the above raw materials not only has good flame retardancy, but also demonstrates very excellent precipitation resistance.

A melt index of polypropylene is 0-100 g/10 min (a temperature of 230° C., and a load of 2.16 kg); a 1% thermal weight loss of melamine pyrophosphate (commercially available) is ≤360° C.; the flame-retardant synergist includes at least one of anhydrous zinc borate, zinc borate 3.5 hydrate, zinc oxide, and zirconium phosphate; the coupling agent is a silane coupling agent, including at least one of an amino silane coupling agent KH-9120, an isocyanate silane coupling agent KT-930, and epoxy silane coupling agents KH-1006 and KH-9130; the lubricant includes at least one of ethylene bis stearamide, pentaerythritol stearate, silicone and amide wax; and the antioxidant includes at least one of an antioxidant 168, an antioxidant 1010 and an antioxidant 1098.

The flame-retardant polypropylene is prepared by the following method:
S1: Add chemically end-capped PAPP-modified APP, melamine pyrophosphate and a flame-retardant synergist into a mixer, and stir at room temperature for 5-30 min.
S2: In a mixture of the S1, increase a temperature of the mixer to 80-160° C., ensure that a temperature of the material in the mixer reaches a set temperature, and then add a coupling agent and continue stirring for 10-30 min.
S3: After cooling the mixture in the S2 to room temperature, add polypropylene, a lubricant and an antioxidant and stir for 5-30 min.
S4: Extrude the mixture of S3 through a twin-screw extruder at a temperature of 180-260° C., and then perform screening and dehydration through processes of drawing and pelletizing, to obtain flame-retardant polypropylene granules.

### Experimental Example 1: Specific Synthesis and Properties Testing of Chemically End-Capped Polypiperazine Pyrophosphate (PAPP)-Modified Ammonium Polyphosphate (APP)

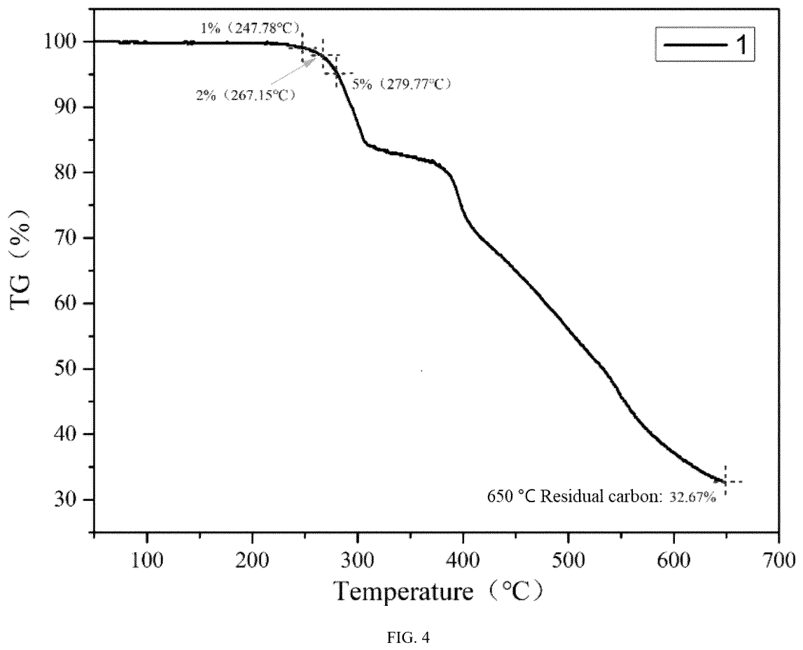

In this experimental example, a specific substance synthesis is performed based on a synthesis route of Example 1, and raw materials and parameters selected are shown in Table 1. Moreover, in a synthesis process of the PAPP and the chemically end-capped PAPP-modified APP (i.e., in the synthesis process from S1 to S3), a special device of this solution is used, and a material stirring screw rotates counterclockwise at a speed of about 200 rpm, and a cylinder of a rotary furnace rotates clockwise at a speed of about 50 rpm. Piperazine diphosphate used in Tests 1-4 is synthesized as follows: mix phosphoric acid and piperazine at a molar ratio of 2.05:1, react in an ethanol-water solution (an ethanol volume fraction of 50%) at 80° C. and 0.1 MPa for 210 min, and then purify and dry by use of a conventional method. Properties of the chemically end-capped PAPP-modified APP obtained by synthesis are tested, including a 1% thermal weight loss temperature and whiteness. The 1% thermal weight loss temperature is measured according to a standard ASTM E2550-2007, and the whiteness is measured according to a standard GB/T 5950, with test results detailed in Table 2. Domestic APP is purchased from the market, and a TG chart is shown in FIG. 4.

TABLE 1
Synthesis conditions of the chemically end-capped PAPP-modified APP

| Items | | Test 1 | Test 2 | Test 3 | Test 4 |
|---|---|---|---|---|---|
| Synthesis | Reaction | Nitrogen | Nitrogen | Nitrogen | Nitrogen |
| of PAPP | environment | | | | |
| | Reaction | 260 | 260 | 280 | 280 |
| | temperature | | | | |
| | (° C.) | | | | |
| | Reaction | 0.05 | 0.1 | 0.2 | 0.05 |
| | pressure (MPa) | | | | |
| | Reaction time | 180 | 180 | 150 | 150 |
| | (min) | | | | |
| PAPP- | PAPP: APP | 2.0:1 | 2.05:1 | 2.05:1 | 2.1:1 |
| modified | (molar ratio) | | | | |
| APP | Reaction | Nitrogen | Nitrogen | Nitrogen | Nitrogen |
| | environment | | | | |
| | Reaction | 240 | 240 | 240 | 240 |
| | temperature | | | | |
| | (° C.) | | | | |
| | Reaction | 0.05 | 0.1 | 0.2 | 0.05 |
| | pressure (MPa) | | | | |
| | Reaction time | 120 | 180 | 120 | 90 |
| | (min) | | | | |
| Synthesis | Types of end- | Melamine | Urea | Biguanide | Iminodi- |
| of the | capping | | | | acetonitrile |
| chemically | reagents | | | | |
| end- | End-capping | 2.05:1 | 2.10:1 | 2.15:1 | 2.15:1 |
| capped | reagent: | | | | |
| PAPP- | chemically end- | | | | |
| modified | capped PAPP- | | | | |
| APP | modified APP | | | | |
| | (molar ratio) | | | | |
| | Reaction | Nitrogen | Nitrogen | Nitrogen | Nitrogen |
| | environment | | | | |
| | Reaction | 240 | 220 | 220 | 220 |
| | temperature | | | | |
| | (° C.) | | | | |
| | Reaction | 0.2 | 0.8 | 0.4 | 0.4 |
| | pressure (MPa) | | | | |
| | Reaction time | 90 | 120 | 120 | 120 |
| | (min) | | | | |

TABLE 2
Properties test results

| | Domestic | | | | |
|---|---|---|---|---|---|
| Sample | APP | Test 1 | Test 2 | Test 3 | Test 4 |
| Whiteness/% | 92.6 | 96.3 | 96.3 | 96.1 | 96.4 |
| 1% thermal | 247.78 | 292.72 | 290.43 | 294.64 | 295.25 |
| weight | | | | | |
| loss/° C. | | | | | |

It can be seen from the above experimental results that the chemically end-capped PAPP-modified APP obtained by the synthesis method of this solution, compared with conventional APP in the prior art, has a more ideal whiteness (greater than 96%) and 1% thermal weight loss temperature (greater than 290° C.).

### Experimental Example 2: Specific Synthesis and Properties Testing of Flame-Retardant Polypropylene

In this experimental example, a specific substance synthesis is performed based on a synthesis route of Example 2, and raw materials and parameters selected are shown below:
Test 1:76.5 parts of polypropylene, 15 parts of chemically end-capped PAPP-modified APP (prepared in Test 1 of Experimental Example 1), 3 parts of melamine pyrophosphate, 3 parts of a flame-retardant synergist, 0.5 part of a coupling agent, 0.5 part of a lubricant, and 0.5 part of an antioxidant.
Test 2:76.5 parts of polypropylene, 15 parts of chemically end-capped PAPP-modified APP (prepared in Test 2 of Experimental Example 1), 3 parts of melamine pyrophosphate, 3 parts of a flame-retardant synergist, 0.5 part of a coupling agent, 0.5 part of a lubricant, and 0.5 part of an antioxidant.
Test 3:76.5 parts of polypropylene, 15 parts of chemically end-capped PAPP-modified APP (prepared in Test 3 of Experimental Example 1), 3 parts of melamine pyrophosphate, 3 parts of a flame-retardant synergist, 0.5 part of a coupling agent, 0.5 part of a lubricant, and 0.5 part of an antioxidant.
Test 4:76.5 parts of polypropylene, 15 parts of chemically end-capped PAPP-modified APP (prepared in Test 4 of Experimental Example 1), 3 parts of melamine pyrophosphate, 3 parts of a flame-retardant synergist, 0.5 part of a coupling agent, 0.5 part of a lubricant, and 0.5 part of an antioxidant.

Comparative test: 76.5 parts of polypropylene, 15 parts of APP (domestic), 3 parts of melamine pyrophosphate, 3 parts of a flame-retardant synergist, 0.5 part of a coupling agent, 0.5 part of a lubricant, and 0.5 part of an antioxidant.

A melt index of polypropylene is specifically 20 g/10 min; the flame-retardant synergist is specifically zinc oxide; the coupling agent is specifically KH-9120; the lubricant is specifically ethylene bis stearamide; and the antioxidant is specifically a compound of mixing an antioxidant 168 and an antioxidant 1010 at a ratio of 1:1.

A composite material is prepared according to the following method:

Add polypropylene, chemically end-capped PAPP-modified APP (or domestic APP), melamine pyrophosphate and a flame-retardant synergist into a mixer, stir at room temperature for 15 min, then increase a temperature of the mixer to 120° C., ensure that a temperature of the material in the mixer reaches a set temperature, and then add a coupling agent and continue stirring for 20 min. After cooling to room temperature, add a lubricant and an antioxidant and stir for 10 min. Extrude a final mixture through a conventional way of the prior art and a twin-screw extruder at a temperature of 160-220° C., and then perform screening and dehydration through processes of drawing and pelletizing, to obtain a composite material of the flame-retardant polypropylene.

The composite material of the flame-retardant polypropylene obtained by synthesis is subjected to properties tests, including a flame retardancy test, a “double 85” test, and an immersion test. The flame retardancy test is conducted based on the Test for Flammability of Plastic Materials for Parts in Devices and Appliances-UL 94; the “double 85” test for 1000 h is conducted based on Part 2 of GB/T 2423.50, with a test method being Test Cy: steady-state damp heat is mainly used for accelerated testing of components; and the immersion test is conducted based on the Polymeric Materials-Use in Electrical Equipment Evaluations-UL 746C, with test results detailed in Table 3.

TABLE 3
Test results of flame-retardant polypropylene properties

| | Flame | | | |
|---|---|---|---|---|
| | Retardancy UL94 | | “Double 85” test | UL746C |
| No. | 3.2 mm | 1.6 mm | for 1000 h | immersion test |
| Com- | Un- | Un- | Precipitation | Precipitation |
| parative | ex- | ex- | on a spline | on a spline |
| tests | tinguished | tinguished | surface | surface |
| Test 1 | V-0 | V-0 | No precipitation | No precipitation |
| | | | on a spline | on a spline |
| | | | surface | surface |
| Test 2 | V-0 | V-0 | No precipitation | No precipitation |
| | | | on a spline | on a spline |
| | | | surface | surface |
| Test 3 | V-0 | V-0 | No precipitation | No precipitation |
| | | | on a spline | on a spline |
| | | | surface | surface |
| Test 4 | V-0 | V-0 | No precipitation | No precipitation |
| | | | on a spline | on a spline |
| | | | surface | surface |

According to the above experimental data, the flame-retardant polypropylene prepared by using this solution, compared with APP (domestic), has relatively ideal retardancy, temperature resistance, and precipitation resistance. A relatively low amount of the chemically end-capped PAPP-modified APP prepared in this solution needs to be added (with an addition proportion of only about 15%) to achieve the following effects: with the flame-retardant effect of 1.6 mm V-0, the flame-retardant polypropylene passes the UL 746C immersion test and the GB/T 2423.50 “double 85” test for 1000 h without precipitation.

### Comparative Example 1

This comparative example is essentially the same as any one of the Tests 1-4 of Experimental Example 2, and the difference lies in that chemically end-capped PAPP-modified APP is replaced with PAPP-modified APP, that is, a product prepared according to the first two steps of Experimental Example 1 (prepared with reference to Test 1 of Experimental Example 1) is no longer chemically end-capped. Flame-retardant polypropylene is prepared by using the obtained PAPP-modified APP, and then properties tests (mechanical properties and flame retardancy) are performed. Experimental results are shown in Table 4 (Tests 1-4 correspond to the Tests 1-4 in Table 3 respectively). The experimental results show that the end-capping of the nitrogen-containing compound containing no hydroxyl group but with an N—H bond used in this solution helps to improve compatibility of remaining polypropylene, mechanical properties and also the flame-retardant effect.

### Comparative Example 2

This comparative example is essentially the same as any one of the Tests 1-4 of Experimental Example 2, and the difference lies in that the chemically end-capped PAPP-modified APP is replaced with a mixture of PAPP (prepared with reference to the Test 1 of Experimental Example 1) and APP, with a molar ratio of 2:1, and properties test results are shown in Table 4. The mixture of PAPP and APP, compared to the chemically modified samples in the Tests 1-4, is much more inferior in the flame retardancy and mechanical properties.

### Comparative Example 3

This comparative example is essentially the same as any one of the Tests 1-4 of Experimental Example 2, and the difference lies in that the chemically end-capped PAPP-modified APP is replaced with a mixture of APP and chemically end-capped PAPP, with a molar ratio of 1:2. A method for preparing the chemically end-capped PAPP is as follows: perform thermal treatment of piperazine diphosphate at 260° C. for 180 min, and in a nitrogen environment, perform thermal polymerization at a pressure of 0.05 MPa for dehydration and condensation into PAPP. After a reaction is completed, add a melamine end-capping reagent (a mass ratio of the end-capping reagent to the PAPP is 10:10000), continue the thermal treatment at a temperature of 280° C. and a pressure of 0.2 MPa for 90 min in an inert gas environment (such as nitrogen), and perform grinding after cooling to obtain the chemically end-capped PAPP.

Properties test results are shown in Table 4. The mixture of APP and chemically end-capped PAPP is used as an additive, which, compared to the chemically modified samples in the Test 1-4, is much more inferior in the precipitation resistance, flame retardancy and mechanical properties, because the end-capping of the nitrogen-containing compound containing no hydroxyl group but with an N—H bond used in this solution helps to improve compatibility of remaining polypropylene, and also the flame-retardant effect.

TABLE 4
Properties test results of Comparative Examples 1-3 (N/A means that a test is not performed)

| | | Comparative | Comparative | Comparative | | | | |
|---|---|---|---|---|---|---|---|---|
| Items | | Example 1 | Example 2 | Example 3 | Test 1 | Test 2 | Test 3 | Test 4 |
| Tensile | | 13.7 | 11.7 | 12.2 | 14.9 | 15.7 | 15.5 | 16.3 |
| strength/MPa | | | | | | | | |
| Notched | | 6.3 | 5.3 | 5.6 | 6.5 | 6.9 | 6.7 | 7.8 |
| impact | | | | | | | | |
| strength/kJ/m² | | | | | | | | |
| Flame | 3.2 mm | V-0 | V-1 | V-1 | V-0 | V-0 | V-0 | V-0 |
| retardancy | 1.6 mm | V-1 | Unextinguished | Unextinguished | V-0 | V-0 | V-0 | V-0 |
| UL94 | | | | | | | | |

| “Double 85” | Precipitation | Precipitation | Precipitation | No | No | No | No |
|---|---|---|---|---|---|---|---|
| test for 1000 h | on a spline | on a spline | on a spline | precipitation | precipitation | precipitation | precipitation |
| | surface | surface | surface | on a spline | on a spline | on a spline | on a spline |
| | | | | surface | surface | surface | surface |
| UL746C | No | Precipitation | Precipitation | No | No | No | No |
| immersion | precipitation | on a spline | on a spline | precipitation | precipitation | precipitation | precipitation |
| test | on a spline | surface | surface | on a spline | on a spline | on a spline | on a spline |
| | surface | | | surface | surface | surface | surface |

According to the above experimental data, when the PAPP-modified APP is not chemically end-capped (Comparative Example 1), any finished product of polypropylene obtained by applying a flame retardant to production of flame-retardant polypropylene, compared with finished products of the Tests 1-4, degrades in the mechanical properties and the flame-retardant effect, with a phenomenon of surface precipitation. When conventional means of the prior art are adopted, PAPP and APP are directly mixed (Comparative Example 2), without chemical bonding. Any finished product of polypropylene obtained by applying a flame retardant to production of flame-retardant polypropylene, compared with finished products of the Tests 1-4 and Comparative Example 1, degrades in the mechanical properties and the flame-retardant effect, with a phenomenon of surface precipitation. When APP and chemically end-capped PAPP are simply mixed, undesirable phenomena such as degraded mechanical properties, surface precipitation and reduced flame-retardant effect will also occur.

### Comparative Example 4

This comparative example is essentially the same as the Test 1 of Experimental Example 1, and the difference lies in that in the three-step synthesis process, only the material stirring screw keeps rotating (consistent with the Test 1 of Experimental Example 1), but the cylinder of the rotary furnace (the reaction chamber) does not rotate, and other parameter conditions remain unchanged. The obtained chemically end-capped PAPP-modified APP is tested in terms of the whiteness and the 1% thermal weight loss temperature, and experimental results are shown in Table 5 (the Test 1 in Table 5 corresponds to the Test 1 in Table 2).

### Comparative Example 5

This comparative example is essentially the same as the Test 1 of Experimental Example 1, and the difference lies in that in the three-step synthesis process, a rotation speed of the material stirring screw is kept to be consistent with that of Test 1 of Experimental Example 1, but a rotation speed of the cylinder of the rotary furnace (the reaction chamber) is 150 rpm (faster rotation), and other parameter conditions remain unchanged. The obtained chemically end-capped PAPP-modified APP is tested in terms of the whiteness and the 1% thermal weight loss temperature, and experimental results are shown in Table 5.

### Comparative Example 6

This comparative example is essentially the same as the Test 1 of Experimental Example 1, and the difference lies in that in the three-step synthesis process, a rotation speed of the material stirring screw is maintained at 350 rpm (faster rotation), but a rotation speed of the cylinder of the rotary furnace (the reaction chamber) is consistent with that of the Test 1 of Experimental Example 1, and other parameter conditions remain unchanged. The obtained chemically end-capped PAPP-modified APP is tested in terms of the whiteness and the 1% thermal weight loss temperature, and experimental results are shown in Table 5.

TABLE 5
Properties test results of the chemically end-capped
PAPP-modified APP in Comparative Examples 4-6

| | Comparative | Comparative | Comparative | |
|---|---|---|---|---|
| Sample | Example 4 | Example 5 | Example 6 | Test 1 |
| Whiteness/% | 91.1 | 93.2 | 94.6 | 96.3 |
| 1% thermal | 266.9 | 271.7 | 276.4 | 292.72 |
| weight loss/° C. | | | | |

In a process of preparing the chemically end-capped PAPP, the material stirring screw and the cylinder of the rotary furnace (the reaction chamber) rotate in different directions at a certain speed, which is very critical for enhancing the whiteness of the flame retardant and reducing the thermal weight loss. When only the material stirring screw rotates, even if its rotation speed is increased (Comparative Example 1->Comparative Example 3), the whiteness and the 1% thermal weight loss temperature of the chemically end-capped PAPP-modified APP obtained are not ideal. When the rotation speed of the cylinder of the rotary furnace (the reaction chamber) is too fast (Comparative Example 2), improvement in the whiteness and 1% thermal weight loss temperature will also be affected.

### Comparative Example 7

This comparative example is essentially the same as the Test 1 of Experimental Example 2, and the difference lies in that when preparing the chemically end-capped PAPP-modified APP, the end-capping reagent is replaced by an equivalent amount of propanol, and other conditions remain unchanged. The obtained flame-retardant polypropylene is tested in properties: the flame retardancy UL 94 (3.2 mm) is V-0, the flame retardancy UL 94 (1.6 mm) is V-1, results of the “double 85” test for 1000 h show the precipitation on a spline surface, and results of the UL 746C immersion test show the precipitation on a spline surface. The inventor has previously attempted to use methanol, ethanol, propanol, and butanol, none of which yielded ideal results, and here propanol is taken as an example for illustration.

### Comparative Example 8

This comparative example is essentially the same as the Test 1 of Experimental Example 2, and the difference lies in that when preparing the chemically end-capped PAPP-modified APP, the end-capping reagent is replaced by an equivalent amount of phenol, and other conditions remain unchanged. The obtained flame-retardant polypropylene is tested in properties: the flame retardancy UL 94 (3.2 mm) is V-0, the flame retardancy UL 94 (1.6 mm) is V-1, results of the “double 85” test for 1000 h show the precipitation on a spline surface, and results of the UL 746C immersion test show the precipitation on a spline surface.

Comparative Examples 7 and 8 illustrate that type selection of the end-capping reagent will also significantly affect the effect of the flame retardant. When an end-capping reagent that does not contain nitrogen but contains hydroxyl groups (various alcohols, phenols, etc.) is used, the flame retardancy of a composite material will degrade and the problem of surface precipitation cannot be completely solved.

What is described above is merely an example of the present disclosure, and common general knowledge such as well-known specific technical schemes and/or characteristics in the solution is not described too much herein. It should be noted that those skilled in the art may further make several transformations and improvements on the premise of not deviating from the technical scheme of the present disclosure, and these transformations and improvements should fall within the scope of protection of the present disclosure without affecting the implementation effect of the present disclosure and the practicability of the patent. The protection scope of the present disclosure shall be determined by the terms of the claims, and the specific embodiments and other records in the specification can be used to interpret the content of the claims.

What is claimed is:

1. A chemically end-capped polypiperazine pyrophosphate (PAPP)-modified ammonium polyphosphate (APP) flame retardant with high temperature resistance and precipitation resistance, wherein a structure of the PAPP-modified APP is represented by a following chemical formula, and the PAPP-modified APP is end-capped by an end-capping reagent; 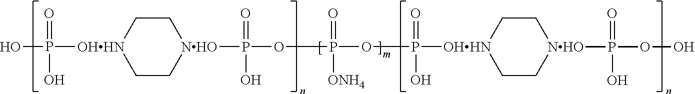
wherein n=300-1500, m=1000-2000; and the end-capping reagent is a nitrogen-containing compound containing no hydroxyl group but with an N—H bond.

2. The chemically end-capped PAPP-modified APP flame retardant with high temperature resistance and precipitation resistance according to claim 1, wherein the end-capping reagent comprises at least one of R—NH₂, R═NH, melamine, urea, biguanide and iminodiacetonitrile; and R is an alkyl group with 1-4 carbon atoms.

3. The chemically end-capped PAPP-modified APP flame retardant with high temperature resistance and precipitation resistance according to claim 2, wherein a molar ratio of the PAPP to the APP is 2.0-2.1:1; and a molar ratio of the end-capping reagent to the PAPP-modified APP is 2.0-2.2:1.

4. A method for preparing a chemically end-capped PAPP-modified APP flame retardant with high temperature resistance and precipitation resistance according to claim 1, comprising the following steps performed sequentially:
S1: dehydrating piperazine diphosphate by thermal polymerization to obtain PAPP;
S2: dehydrating the PAPP and APP by the thermal polymerization to obtain PAPP-modified APP; and
S3: performing thermal treatment of the PAPP-modified APP and the end-capping reagent, to obtain the chemically end-capped PAPP-modified APP.

5. The method for preparing a chemically end-capped PAPP-modified APP flame retardant with high temperature resistance and precipitation resistance according to claim 4, wherein reaction processes of S1-S3 are all executed in an inert gas environment; a reaction temperature, pressure and time of S1 are 120-320° C., 0.05-0.3 MPa, and 30-240 min, respectively; a reaction temperature, pressure and time of S2 are 150-280° C., 0.05-0.3 MPa, and 30-180 min, respectively; and a reaction temperature, pressure and time of S3 are 120-350° C., 0.1-1.5 MPa, and 30-240 min, respectively.

6. The method for preparing a chemically end-capped PAPP-modified APP flame retardant with high temperature resistance and precipitation resistance according to claim 5, wherein the reaction processes of S1-S3 are all executed in a thermal polymerization reaction device; the thermal polymerization reaction device comprises a rotary furnace and a temperature control unit; a reaction chamber is arranged in the rotary furnace, and a material stirring screw is coaxially arranged in the reaction chamber; the temperature control unit is configured for controlling a temperature in the reaction chamber; and during the reaction process, the material stirring screw and the reaction chamber maintain different rotation directions.

7. The method for preparing a chemically end-capped PAPP-modified APP flame retardant with high temperature resistance and precipitation resistance according to claim 6, wherein a rotation speed of the material stirring screw is 30-300 rpm, and a rotation speed of the reaction chamber is 3-120 rpm.

8. An application of the chemically end-capped PAPP-modified APP flame retardant with high temperature resistance and precipitation resistance according to claim 1 in flame-retardant polypropylene.

9. The application of the chemically end-capped PAPP-modified APP flame retardant with high temperature resistance and precipitation resistance in flame-retardant polypropylene according to claim 8, wherein the flame-retardant polypropylene comprises the following raw materials in parts by weight: 70-78 parts of polypropylene, 10-20 parts of chemically end-capped PAPP-modified APP, 5-15 parts of melamine pyrophosphate, 0.5-6 parts of a flame-retardant synergist, 0.5-2 parts of a coupling agent, 0.3-3 parts of a lubricant, and 0.2-0.5 part of an antioxidant;
A melt index of polypropylene is 0-100 g/10 min; a 1% thermal weight loss of melamine pyrophosphate is ≤360° C.; the flame-retardant synergist comprises at least one of anhydrous zinc borate, zinc borate 3.5 hydrate, zinc oxide, and zirconium phosphate; the coupling agent is a silane coupling agent, comprising at least one of an amino silane coupling agent KH-9120, an isocyanate silane coupling agent KT-930, and epoxy silane coupling agents KH-1006 and KH-9130; the lubricant comprises at least one of ethylene bis stearamide, pentaerythritol stearate, silicone powder and amide wax; and the antioxidant comprises at least one of an antioxidant 168, an antioxidant 1010 and an antioxidant 1098.

10. The application of the chemically end-capped PAPP-modified APP flame retardant with high temperature resistance and precipitation resistance in flame-retardant polypropylene according to claim 9, wherein the flame-retardant polypropylene is prepared by the following method: adding chemically end-capped PAPP-modified APP, melamine pyrophosphate and a flame-retardant synergist into a mixer and stirring at room temperature for 5-30 min; then increasing a temperature of the mixer to 80-160° C., and adding a coupling agent and continuing to stir for 10-30 min; after cooling to room temperature, adding polypropylene, a lubricant and an antioxidant and stirring for 5-30 min; and obtaining flame-retardant polypropylene by extruding with a twin-screw extruder.
